(19) United States
(12) Patent Application Publication
(10) Pub. No.: US 2013/0342801 A1
(43) Pub. Date: Dec. 26, 2013

(54) LIQUID CRYSTAL DISPLAY DEVICE

(71) Applicants: Hiroshi Hamada, Osaka-shi (JP); Kengo Takahama, Osaka-shi (JP); Shinichi Miyazaki, Osaka-shi (JP)

(72) Inventors: Hiroshi Hamada, Osaka-shi (JP); Kengo Takahama, Osaka-shi (JP); Shinichi Miyazaki, Osaka-shi (JP)

(73) Assignee: SHARP KABUSHIKI KAISHA, Osaka-shi, Osaka (JP)

(21) Appl. No.: 14/002,463

(22) PCT Filed: Feb. 27, 2012
(86) PCT No.: PCT/JP2012/054836

§ 371 Date: Aug. 30, 2013

(30) Foreign Application Priority Data
Mar. 3, 2011 (JP) 2011-046895

(51) Int. Cl. G02F 1/1333

(52) U.S. Cl. CPC G02F 1/13338
USPC 349/141

(57) ABSTRACT

The liquid crystal display device (1) includes (i) a plurality of pixels arranged in a matrix manner for carrying out display, (ii) pixel electrodes (20) each of which has a comb-teeth shaped region, (iii) common electrodes (24) which face the respective pixel electrodes (20) via an insulating layer and each of which has a plate-like shape, (iv) a plurality of CSY lines (14), and (v) a plurality of CSX lines (16) which perpendicularly intersect with the plurality of CSY lines (14). Each of the common electrodes (24) is connected with any of the plurality of CSY lines (14) or with any of the plurality of CSX lines (16).

### TECHNICAL FIELD

The present invention relates to a liquid crystal display device including an in-cell touch panel.

### BACKGROUND ART

Conventionally, a display device has been produced which includes a touch panel that has a function to detect a pressed location on a screen. In the past, such a display device including a touch panel was generally configured by attaching a film-shaped touch panel on a display surface of the display device. Meanwhile, recently, a display device including a so-called in-cell touch panel has been actively developed. According to the display device including the in-cell touch panel, wires and the like which are necessary for detecting a pressed location on a screen are incorporated in a display panel that constitutes the display device. Among such display devices, attention is being given to a display device including a so-called electrostatic projection touch panel which is capable of (i) simultaneously detecting a plurality of points and/or (ii) detecting a pressing which is made not only with a finger but also with an artifact such as a pen.

In a case where an in-cell touch panel is provided in a conventional liquid crystal display device, a configuration as below has been generally employed. First, the liquid crystal display device includes a TFT substrate and a color filter substrate. On the TFT substrate, pixel electrodes are provided. On the color filter substrate, a common electrode is provided so as to face the pixel electrodes. The common electrode has a whole sheet shape and is formed on an entire surface of the color filter substrate. According to the configuration, a single common electrode is provided for the pixel electrodes. A drive electrode and a receive electrode (hereinafter, collectively referred to as “detection electrode”), which constitute the touch panel, are provided on the TFT substrate. A pressed location on a display surface is detected by detecting a change in coupling capacitance between the electrodes.

However, such a configuration has a problem that coordinates cannot be detected with high accuracy. The reasons are as follows: A distance between a counter electrode for display and the detection electrode is merely 3 μm to 4 μm. Therefore, a coupling capacitance between the electrodes is extremely large. Meanwhile, a distance between (i) a finger which presses the display surface and (ii) the detection electrode is as long as several millimeters. Therefore, a coupling capacitance between the finger and the detection electrode is extremely small. This causes a change amount of coupling capacitance, which is generated between the drive electrode and the receive electrode when the finger presses the display surface, to be undistinguishable from the coupling capacitance between the counter electrode and the detection electrode. Therefore, an SN ratio obtained when the change amount is detected becomes small, and accordingly coordinates cannot be detected with high accuracy.

In view of this, conventionally, a technique has been proposed in which an in-cell touch panel is provided in a liquid crystal display device which does not include a counter electrode having a whole sheet shape. For example, Patent Literatures 1 and 2 disclose concrete examples of such a technique.

Patent Literature 1 discloses a technique to provide a touch panel in an in-plane-switching (IPS) liquid crystal display device. According to the technique, one of a pair of IPS-based electrodes, which have a comb-teeth shape, is used as a drive electrode or a receive electrode of a touch panel (see FIG. 105 and FIG. 106 of Patent Literature 1).

Patent Literature 2 discloses a technique in which an electrode (a common electrode or a lower electrode) which forms a capacitive element in a pixel is connected to a common voltage line extending in an X direction or a common voltage line extending in a Y direction so that the electrode can be used as a drive electrode or a receive electrode of a touch panel. Both the common electrode and the lower electrode have a comb-teeth shape. A disconnecting part (break) is provided on each of the common voltage lines so as to achieve (i) electrical insulation between the drive electrodes and (ii) electrical insulation between the receive electrodes. This makes it possible to form a drive electrode block and a receive electrode block which have a shape in accordance with locations of the disconnecting parts.

### CITATION LIST

### Patent Literatures

Patent Literature 1: US Patent Application Publication No. US2008/0062139A1 (Publication date: Mar. 13, 2008)

Patent Literature 2: US Patent Application Publication No. US2010/0001973A1 (Publication date: Jan. 7, 2010)

### SUMMARY OF INVENTION

### Technical Problem

However, according to the techniques of Patent Literatures 1 and 2, an electric potential distribution between the drive electrode and the receive electrode varies depending on whether or not an image is displayed. In order to deal with such a variation, it is necessary to correct a detection signal. The following description will discuss this problem with reference to FIG. 9.

(a) of FIG. 9 illustrates an electrode structure in a pixel, in accordance with a conventional technique. (b) of FIG. 9 illustrates lines of electric force generated between a drive electrode and a receive electrode when an image is displayed. (c) of FIG. 9 illustrates lines of electric force generated between the drive electrode and the receive electrode when no image is displayed. Each of A-B cross sections illustrated in respective (b) and (c) of FIG. 9 is taken along the line A-B in (a) of FIG. 9.

According to the conventional technique, a pixel electrode 100a having a comb-teeth shape and a common electrode 102a are provided in an identical plane in a certain pixel of a liquid crystal display device (see (a) of FIG. 9). In an adjacent pixel which is located next to the certain pixel, a pixel electrode 100b having a comb-teeth shape and a common electrode 102b are provided in an identical plane. In other words, the pixel electrode 100a, the pixel electrode 100b, the common electrode 102a, and the common electrode 102b all exist in the identical plane.

According to the conventional technique, the common electrode 102a serves as a drive electrode of a touch panel, and the common electrode 102b serves as a receive electrode of the touch panel. Hereinafter, the common electrode 102a is referred to as “drive electrode 102a”, and the common electrode 102b is referred to as “receive electrode 102b”.

When an image is displayed, voltages of 0 V to 5 V are applied to the pixel electrode 100a and the pixel electrode 100b, respectively. This voltage varies depending on a material of liquid crystal and on a content to be displayed. Hereinafter, the voltage applied to the pixel electrode 100a is referred to as “V₁”, and the voltage applied to the pixel electrode 100b is referred to as “V₂” (see (a) of FIG. 9).

When a pressing on the display surface is detected, a driving voltage of 3 V to 5 V is applied to the drive electrode 102a. Meanwhile, no voltage is applied to the receive electrode 102b. Hereinafter, the voltage applied to the receive electrode 102b is referred to as “V3”, and the voltage applied to the receive electrode 102b is referred to as “V4”.

In a case where V3=3 V and V4=0 V, lines of electric force 104 are generated between the drive electrode 102a and the receive electrode 102b in order to sense a touch (see (b) of FIG. 9). Here, when a finger touches a display surface 106, a part of the lines of electric force 104 within a range 108 contributes to the sensing. In (b) of FIG. 9, the voltage V₁ is 3 V for displaying an image. In this case, since V₁=V₃=3 V, no line of electric force is generated between the pixel electrode 100a and the drive electrode 102a at all.

On the other hand, in a case where no image is displayed, V₁=0V (see (c) of FIG. 9). Here, the drive electrode 102a is located closer to the pixel electrode 100a than to the receive electrode 102b. This causes lines of electric force 110 to be generated between the drive electrode 102a and the pixel electrode 100a. Consequently, the number of lines of electric force 110 falling within the range 108 becomes smaller than that illustrated in (b) of FIG. 9.

As above described, according to the conventional technique, an electric potential of a pixel electrode varies depending on whether or not an image is displayed. Due to the variation in electric potential, an electric potential distribution between the drive electrode 102a and the receive electrode 102b is changed depending on whether or not an image is displayed. This causes lines of electric force, which contribute to sensing, to be increased or decreased, and accordingly a signal, which is generated when a pressing is detected, is increased or decreased depending on whether or not an image is displayed. In view of this, a technique is required in which a detection signal, which is generated when a pressing is detected, is corrected in accordance with an image to be displayed.

According to the technique of Patent Literature 2, it is necessary to provide a disconnecting part on the common voltage line. This restricts a shape of the electrode block to a certain degree. That is, flexibility in forming a block is low.

The present invention is accomplished in order to solve the problems. An objective of the present invention is to provide a liquid crystal display device including an in-cell touch panel, which (i) does not require correction of a detection signal generated when a pressing is detected and (ii) can (a) group drive electrodes into a block and (b) group receive electrodes into a block, more flexibly.

### Solution to Problem

In order to attain the object, a liquid crystal display device in accordance with an aspect of the present invention includes:

a plurality of pixels which are arranged in a matrix manner for carrying out display;

pixel electrodes provided for the respective plurality of pixels, each of the pixel electrodes having a comb-teeth shaped region;

common electrodes which (i) are provided for the respective plurality of pixels and (ii) face the respective pixel electrodes via an insulating layer, each of the common electrodes having a plate-like shape;

a plurality of drive lines; and

a plurality of receive lines which perpendicularly intersect with the plurality of drive lines,

each of the common electrodes being connected with any of the plurality of drive lines or with any of the plurality of receive lines.

According to the configuration, each of the plate-shaped common electrodes, which are provided independently for the respective pixels, is connected with any of the drive lines or any of the receive lines. Common electrodes connected with the drive lines serve as drive electrodes of the touch panel. Meanwhile, common electrodes connected with the receive lines serve as receive electrodes of the touch panel. As such, an in-cell touch panel is provided in the liquid crystal display device in accordance with an aspect of the present invention.

Each of the drive electrode and the receive electrode is not a comb-teeth shaped electrode but is a plate-like electrode. The drive electrode and the receive electrode are provided in a plane which is different from a plane in which the pixel electrode is provided. Therefore, even in a case where an electric potential of the pixel electrode varies depending on whether or not an image is displayed, the lines of electric force generated between the drive electrode and the receive electrode are not increased or decreased. With the configuration, in a case where identical pressings are made with respect to the display surface, completely identical detection signals are obtained regardless of whether or not an image is displayed. Therefore, it is not necessary to correct a detection signal depending on whether or not an image is displayed.

Whether each of the common electrodes serves as a drive electrode or as a receive electrode is determined based on whether the common electrode is connected with a drive line or with a receive line. Therefore, in a case where a block is intended to be made up of a certain number of common electrodes, such a block can be configured by merely connecting the certain number of common electrodes to drive lines. That is, in a case where a plurality of common electrodes are grouped into a block, it is not necessary to (i) electrically connect the drive line with the receive line or (ii) provide disconnecting parts at arbitrary locations on the drive line and on the receive line. Therefore, according to the liquid crystal display device in accordance with an aspect of the present invention, it is possible to flexibly configure a drive electrode block and a receive electrode block which have arbitrary shape and size.

As such, according to the liquid crystal display device in accordance with an aspect of the present invention, it is not necessary to correct a detection signal generated when a pressing is detected, and it is possible to group the drive electrodes into a block and to group the receive electrodes into a block, more flexibly.

For a fuller understanding of the other objects, natures, excellent points, and advantages of the present invention, reference should be made to the ensuing detailed description taken in conjunction with the accompanying drawings.

### Advantageous Effects of Invention

According to the liquid crystal display device in accordance with an aspect of the present invention, it is not necessary to correct a detection signal generated when a pressing is detected, and it is possible to group the drive electrodes into a block and to group the receive electrodes into a block, more flexibly.

### BRIEF DESCRIPTION OF DRAWINGS

FIG. 1 is a view schematically illustrating a configuration of a liquid crystal display device, in accordance with an embodiment of the present invention.

FIG. 2 is a view schematically illustrating a cross section of a liquid crystal display device, in accordance with an embodiment of the present invention.

FIG. 3 is a view illustrating a liquid crystal display device which is configured such that (i) common electrodes for four rows serve as one (1) drive electrode block and (ii) common electrodes for 12 rows serve as one (1) receive electrode block.

FIG. 4 is a view illustrating an equivalent circuit in which a pressing of a finger on a display surface of a liquid crystal display device is detected, in accordance with an embodiment of the present invention.

FIG. 5 is a view illustrating a principle in which a pressing of a finger on a display surface of a liquid crystal display device is detected, in accordance with an embodiment of the present invention.

FIG. 6 illustrates (a) lines of electric force generated in a liquid crystal display device of a conventional technique and (b) lines of electric force generated in a liquid crystal display device in accordance with an embodiment of the present invention.

FIG. 7 illustrates, in (a) through (d), patterns of drive electrode blocks and receive electrode blocks.

FIG. 8 is a view illustrating electrostatic switches which are configured by drive electrodes and are provided in a liquid crystal display device 1.

FIG. 9 illustrates (a) an electrode structure in a pixel in accordance with a conventional technique, (b) lines of electric force generated between a drive electrode and a receive electrode when an image is displayed, and (c) lines of electric force generated between the drive electrode and the receive electrode when no image is displayed.

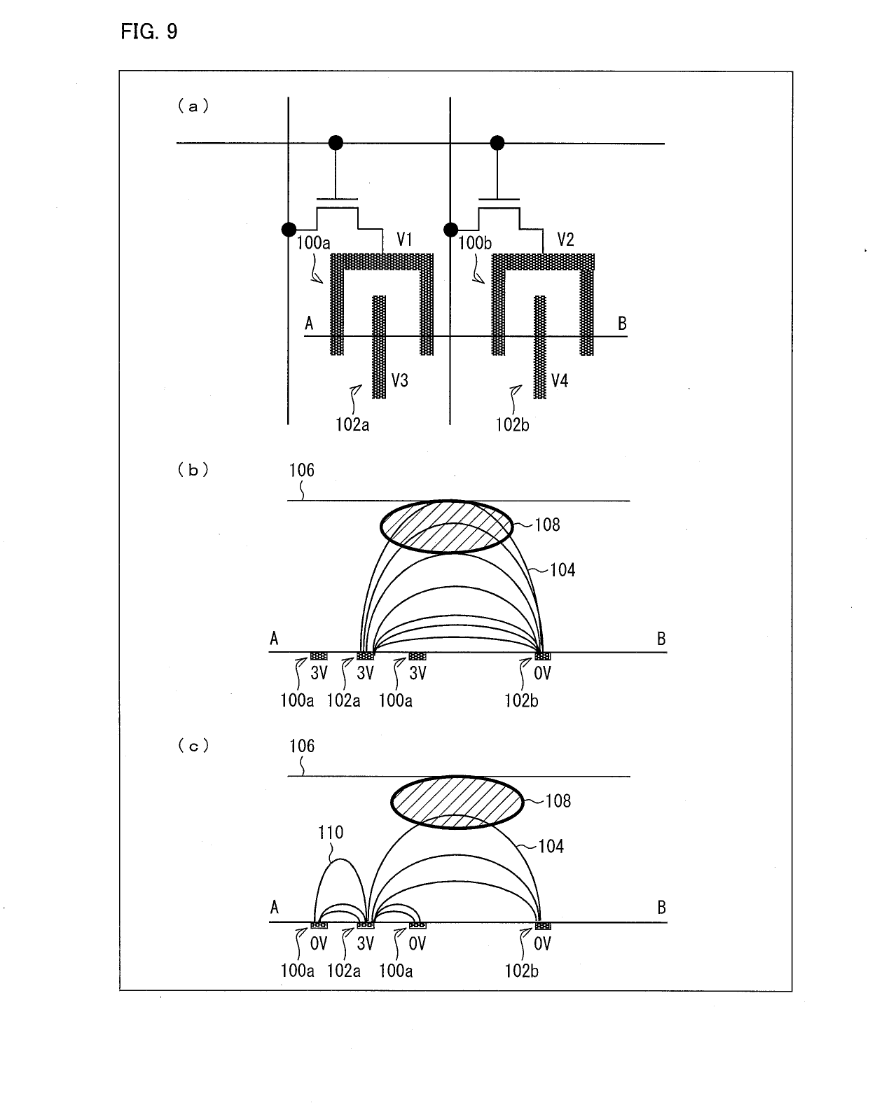

### DESCRIPTION OF EMBODIMENTS

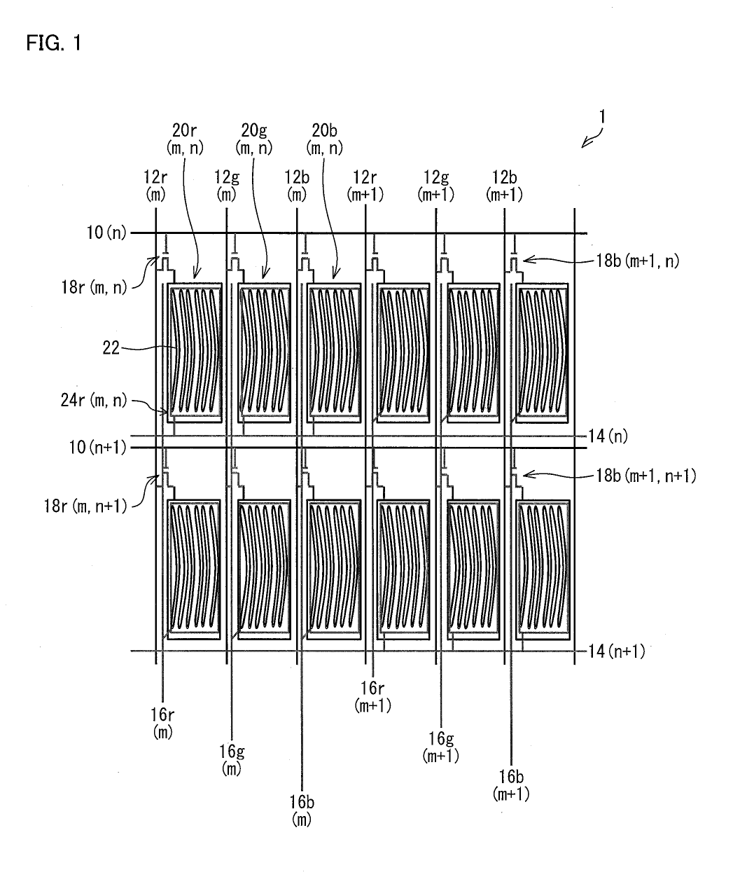

The following description will discuss an embodiment of the present invention, with reference to FIGS. 1 through 6.

(Configuration of Liquid Crystal Display Device 1)

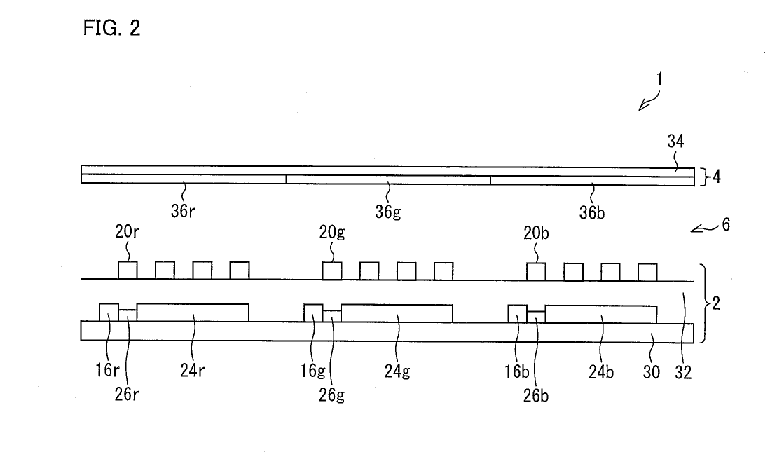

The following description will discuss a configuration of a liquid crystal display device 1 of the present embodiment, with reference to FIGS. 1 and 2. FIG. 1 is a view schematically illustrating a configuration of the liquid crystal display device 1, in accordance with an embodiment of the present invention. FIG. 2 is a view schematically illustrating a cross section of the liquid crystal display device 1, in accordance with an embodiment of the present invention.

The liquid crystal display device 1 includes at least a pair of transparent substrates 2 and 4 and a liquid crystal layer 6 provided between the transparent substrates 2 and 4 (see FIG. 2). One of the pair of transparent substrates 2 and 4 is a TFT substrate 2, and the other of the pair of transparent substrates 2 and 4 is a color filter substrate 4. In the TFT substrate 2, a pixel circuit configured by a pixel electrode, a thin film transistor (TFT), and the like is provided. Meanwhile, in the color filter substrate 4, three color filters (red, blue, and green) necessary for carrying out a color display are provided. Details of these configurations will be described later.

The liquid crystal display device 1 includes a plurality of pixels arranged in a matrix for carrying out display. Specifically, the plurality of pixels are a pixel group of N rows (N is an integer not smaller than 2)×M columns (M is an integer not smaller than 2). Each of the plurality of pixels is made up of three sub-pixels. Accordingly, the liquid crystal display device 1 has sub-pixels whose number is N rows×M rows×3. Each of the sub-pixels is provided for displaying any of primary colors, i.e., red, green, and blue. By thus having the three kinds of sub-pixels, the liquid crystal display device 1 can display an intended color image.

Note that the terms “pixel” and “sub-pixel” are uses merely for convenience. In other words, the technical scope of the present invention of course encompasses even a configuration in which members, which are referred to as “sub-pixel” in the present embodiment, are instead referred to as “pixel”.

The liquid crystal display device 1 includes a plurality of gate bus lines 10 and a plurality of data bus lines 12 which perpendicularly intersect with the plurality of gate bus lines 10. The plurality of gate bus lines 10 and the plurality of data bus lines 12 are formed in the TFT substrate 2. According to the present embodiment, the number of the gate bus lines 10 is N, which is equal to the number of pixel rows. Moreover, the number of the data bus lines 12 is 3×M, which is equal to the number of sub-pixel columns. The sub-pixels are provided at respective intersections of the gate bus lines 10 and the data bus lines 12.

Each of the sub-pixels is made up of at least a TFT 18, a pixel electrode 20, and a common electrode 24. These members are formed in the TFT substrate 2. The TFT 18 has a gate with which the gate bus line 10 is connected. The TFT 18 has a source with which the data bus line 12 is connected. The TFT 18 has a drain with which the pixel electrode 20 is connected.

The common electrode 24 is provided on a surface of a transparent substrate 30, which surface is located on a liquid crystal layer 6 side (see FIG. 2). The common electrode 24 is provided for each pixel, more properly, the common electrode 24 is provided for each of sub-pixels constituting a pixel. In the TFT substrate 2, an insulating layer 32 is provided so as to cover the common electrodes 24. The pixel electrodes 20 are provided at locations on the insulating layer 32, which locations face the respective common electrodes 24.

In each of the pixel electrodes 20, a plurality of long and thin slits 22 are formed and arranged side by side (see FIG. 1). This forms long and thin electrodes, which are arranged side by side via the slits 22, in the pixel electrode 20. In other words, the pixel electrode 20 has a so-called comb-teeth shaped region. On the other hand, the common electrode 24 has a plate-like shape, unlike the pixel electrode 20. As such, according to the liquid crystal display device 1, the pixel electrodes 20 and the common electrodes 24 in pixels are configured so as to correspond to an advanced fringe field switching (AFFS) mode. This makes it possible to enhance an aperture ratio of a pixel and to sufficiently increase a viewing angle of the liquid crystal display device 1.

Each of the pixel electrode 20 and the common electrode 24 is made of a transparent conductive material such as ITO or IZO.

The color filter substrate 4 is configured by a transparent substrate 34, a color filter 36r for displaying red, a color filter 36g for displaying green, and a color filter 36b for displaying blue (see FIG. 2). The color filters 36r through 36g are provided on a surface of the transparent substrate 34, which surface is located on the liquid crystal layer 6 side. By thus including the color filters 36r through 36g, the liquid crystal display device 1 can display a color image of the three primary colors.

In this specification, a character “n” given to each reference numeral means an integer which is not smaller than 1 and is not larger than N. A character “m” given to each reference numeral means an arbitrary integer which is not smaller than 1 and is not larger than M. A character “r” means red, a character “g” means green, and a character “b” means blue. For example, a “gate bus line 10n” indicates an n-th gate bus line 10. A “data bus line 12b(m)” indicates a data bus line 12 which corresponds to green sub-pixels included in respective pixels in an m-th column. A “pixel electrode 20g(m,n)” indicates a pixel electrode 20 constituting a blue sub-pixel included in a pixel located in an n-th row and an m-th column. These rules are similarly applied to the other constituent members.

(CSY Line 14 and CSX Line 16)

The liquid crystal display device 1 includes a plurality of CSY lines 14 (drive line) and a plurality of CSX lines 16 (receive line) which perpendicularly intersect with the plurality of CSY lines 14 (see FIG. 1). According to the present embodiment, the CSY lines 14 extend in parallel with the gate bus lines 10. Meanwhile, the CSX lines 16 extend in parallel with the data bus lines 12. Note, however, that the present embodiment is not limited to this, and the CSY lines 14 can extend in parallel with the data bus lines 12 and the CSX lines 16 can extend in parallel with the gate bus lines 10.

According to the present embodiment, the number of the CSY lines 14 is equal to that of the gate bus lines 10, and the number of the CSX lines 16 is equal to that of the data bus lines 12.

(Drive Electrode and Receive Electrode)

According to the liquid crystal display device 1, each of the common electrodes 24 is connected with any of the CSY lines 14 or with any of the CSX lines 16 via a connection line 26. A common electrode 24 connected with a CSY line 14 serves as a drive electrode of a touch panel, and a common electrode 24 connected with a CSX line 16 serves as a receive electrode of the touch panel. FIG. 2 illustrates a configuration in which a common electrode 24 is connected with a CSX line 16 via a connection line 26.

The liquid crystal display device 1 further includes a sensing driving circuit (not illustrated). The sensing driving circuit is connected with all the CSY lines 14 so as to supply a driving signal for sensing via the CSY lines 14. The term “sensing” means a process of detecting a pressed location on a display surface (sensor surface) of the liquid crystal display device 1.

The liquid crystal display device 1 further includes a sensing detection circuit (not illustrated). The sensing detection circuit is connected with all the CSX lines 16 so as to receive detection signals supplied via the CSX lines 16. By analyzing received detection signals, coordinates of a pressed location on the sensor surface are calculated.

(Connection Pattern of Common Electrodes 24)

In one (1) pixel row, (i) a pixel having common electrodes 24 connected with a CSY line 14 and (ii) a pixel having common electrodes 24 connected with respective CSX lines 16 are alternately arranged (see FIG. 1). More specifically, in one (1) sub-pixel row, (i) sub-pixels having respective common electrodes 24 connected with a CSY line 14 alternate with (ii) sub-pixels having respective common electrodes 24 connected with respective CSX lines 16, for every three sub-pixels (i.e., an R sub-pixel, a G sub-pixel, and a B sub-pixel) constituting one (1) pixel. For example, common electrodes 24 provided for respective of an R sub-pixel 20r(m,n), a G sub-pixel 20g(m,n), and a B sub-pixel b(m,n) are connected with a CSY line 14(n). Meanwhile, common electrodes 24 provided for respective of an R sub-pixel 20r(m+1,n), a G sub-pixel 20g(m+1,n), and a B sub-pixel 20b(m+1,n) are connected with respective CSX lines 16(m+1).

Moreover, although not illustrated in FIG. 1, common electrodes 24 provided for respective of an R sub-pixel 20r(m+2,n), a G sub-pixel 20g(m+2,n), and a B sub-pixel 20b(m+2,n), which constitute a next pixel in an identical pixel row, are connected with the CSX line 14(n).

Note that, also in one (1) pixel column, (i) a pixel having common electrodes 24 connected with a CSY line 14 and (ii) a pixel having common electrodes 24 connected with respective CSX lines 16 are alternately arranged. More specifically, in one (1) sub-pixel column, (i) a sub-pixel having a common electrode 24 connected with a CSY line 14 and (ii) a sub-pixel having a common electrode 24 connected with a CSX line 16 alternate with each other for each sub-pixel. For example, the R sub-pixel 20r(m,n) is connected with the CSY line 14(n), and an R sub-pixel 20r(m,n+1), which is a next sub-pixel in an identical column, is connected with a CSX line 16r(m). Similarly, the G sub-pixel 20g(m,n) is connected with the CSY line 14(n), and a G sub-pixel 20g(m,n+1), which is a next sub-pixel in an identical column, is connected with a CSX line 16r(m).

Although not illustrated in FIG. 1, a further next R sub-pixel 20r(m,n+2) in the m-th column is connected with a CSY line 14(m+2). Similarly, a G sub-pixel 20g(m,n+2) in the m-th column is also connected with the CSY line 14(m+2).

(Forming of Drive Electrode Block and Receive Electrode Block)

According to the liquid crystal display device 1, a plurality of CSY lines 14, which are arranged side by side, are bundled and connected with one (1) common drive line, and it is therefore possible to cause common electrodes 24, which are connected with the bundled CSY lines 14, to serve as one (1) drive electrode block. Meanwhile, a plurality of CSX lines 16, which are arranged side by side, are bundled and connected with one (1) common receive line, and it is therefore possible to cause common electrodes 24, which are connected with the bundled CSX lines 16, to serve as one (1) receive electrode block.

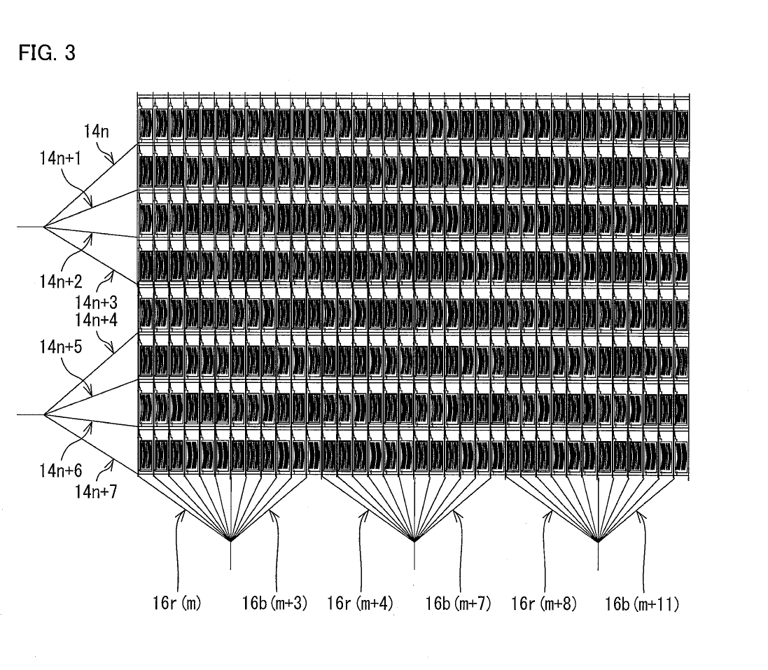

FIG. 3 illustrates a concrete example. FIG. 3 is a view illustrating the liquid crystal display device 1 which is configured such that (i) common electrodes 24 in four rows serve as one (1) drive electrode block and (ii) common electrodes 24 in 12 rows serve as one (1) receive electrode block.

In the example illustrated in FIG. 3, every common drive line is connected with four rows of CSY lines. For example, four CSY lines 14(n) through 14(n+3) are connected with a first common drive line. With the configuration, when a driving signal is supplied to the first common drive line, the identical driving signal is consequently supplied to the CSY lines 14(n) through 14(n+3). This allows common electrodes 24, which are connected with the CSY lines 14(n) through 14(n+3), to serve as a first drive electrode block which is to be driven at an identical timing.

Moreover, in the example illustrated in FIG. 3, following four CSY lines 14(n+4) through 14(n+7) are connected with a following (second) common drive line. With the configuration, when a driving signal is supplied to the second drive line, the identical driving signal is consequently supplied to the CSY lines 14(n+4) through 14(n+7). This allows common electrodes 24, which are connected with the CSY lines 14(n+4) through 14(n+7), to serve as a second drive electrode block which is to be driven at an identical timing.

Meanwhile, in the example illustrated in FIG. 3, every common receive line is connected with 12 rows (for 4 pixels×3) of CSX lines 16. For example, 12 CSX lines, i.e., CSX lines 16r(m) through 16b(m+3) are connected with a first common receive line. With the configuration, a receive signal, which is generated, as a result of a sensing, by a common electrode 24 (receive electrode) connected with any of the CSX lines 16r(m) through 16g(n+3), is ultimately sent to the first common receive line. This allows common electrodes 24, which are connected with the CSX lines 16(n) through 16(n+3), to serve as a first receive electrode block which generates receive signals at an identical timing when sensing is carried out.

Moreover, in the example illustrated in FIG. 3, following four CSX lines 16r(m+4) through 16b(m+7) are connected with a following (second) common receive line. With the configuration, a receive signal, which is generated, as a result of a sensing, by a common electrode 24 (receive electrode) connected with any of the CSX lines 16r(m+4) through 16g(m+7), is ultimately sent to the second common receive line. This allows common electrodes 24, which are connected with the CSX lines 16(n) through 16(n+3), to serve as a first receive electrode block which generates receive signals at an identical timing when sensing is carried out.

As such, according to the example illustrated in FIG. 3, drive electrodes and receive electrodes, which correspond to a size of a block of 4×12 pixels, are provided on the sensor surface. Note that this configuration is merely an example, and the number of CSX lines 16 to be bundled and the number of CSY lines 14 to be bundled are not limited to particular numbers. Therefore, such numbers of lines to be bundled can be determined as appropriate in accordance with an intended purpose. In other words, an intended size of drive electrode block and an intended size of receive electrode block can be formed. Note that, in a case where a width of each block is set to be a width (approximately 4 mm to 5 mm) so that the block has an area which is half of a size of a finger to touch the sensor surface, it is possible to maximally enhance efficiency in detecting a finger.

Note that, in the example illustrated in FIG. 3, a pattern in which the common electrodes 24 are connected with CSX lines 16 or with CSY lines 14 is identical with that illustrated in FIG. 1.

(Equivalent Circuit)

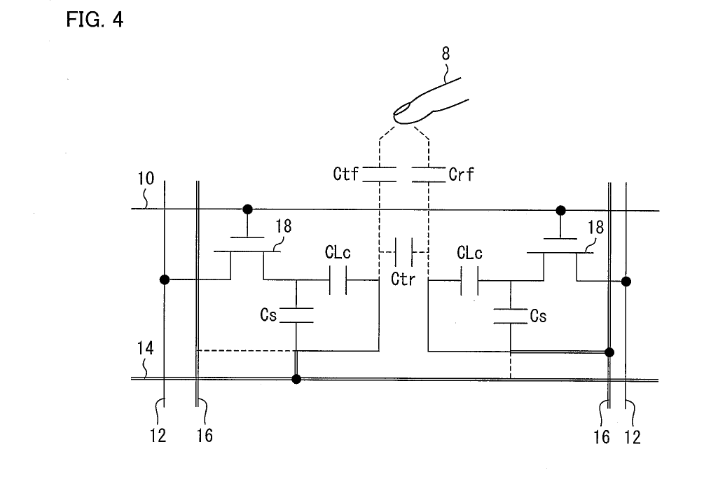

FIG. 4 is a view illustrating an equivalent circuit of a state where a finger 8 which is pressing on the display surface of the liquid crystal display device 1 is detected. According to the liquid crystal display device 1, it is possible to detect a change in capacitance between (i) a common electrode 24 (drive electrode) connected with a CSY line 14 and (ii) a common electrode 24 (receive electrode) connected with a CSX line 16 (see FIG. 4).

In the example illustrated in FIG. 4, the drive electrode and the receive electrode are adjacent to each other. Note, however, that the present embodiment is not limited to this. That is, a change in capacitance can also be detected, with a similar principle, between (i) a block of a plurality of common electrodes 24 (drive electrode block) connected with any of grouped CSY lines 14 and (ii) a plurality of common electrodes 24 (receive electrode block) connected with any of grouped CSX lines 16.

(Detection Principle)

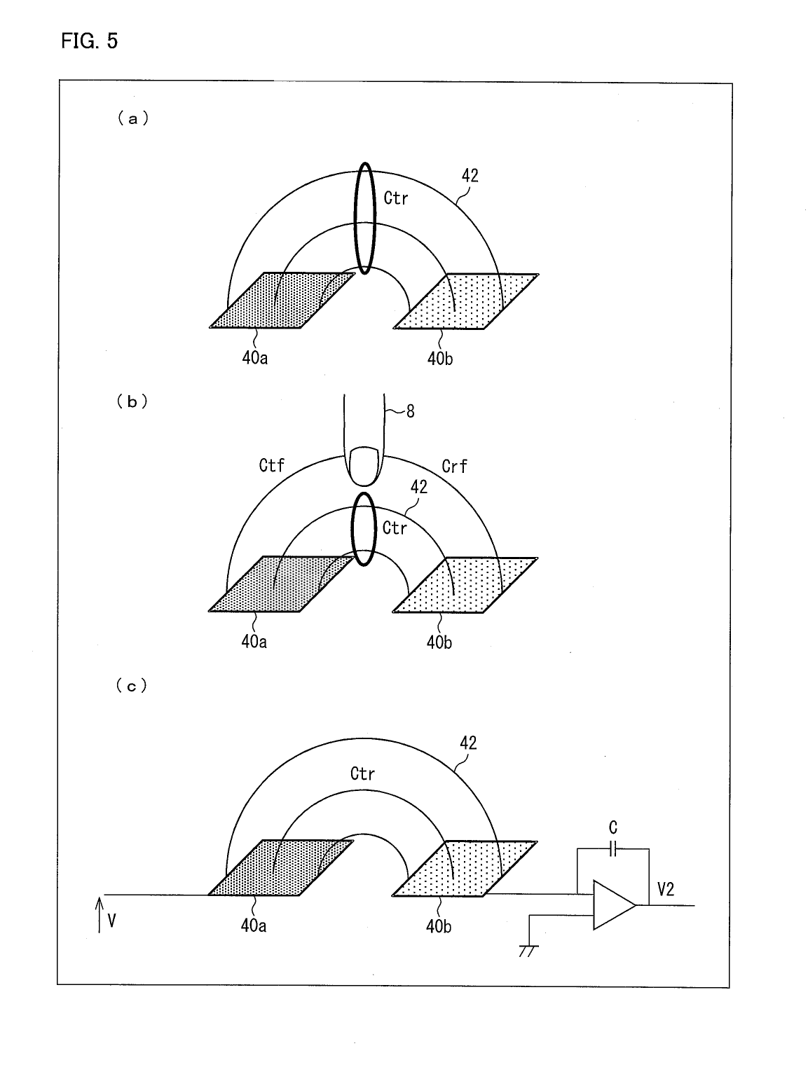

FIG. 5 is a view illustrating a principle in which a pressing of the finger 8 on the display surface of the liquid crystal display device 1 is detected. As illustrated in (a) of FIG. 5, a predetermined capacitance Ctr and lines of electric force 42 are formed between a drive electrode 40a and a receive electrode 40b. In a case where the finger 8 approaches the display surface, the lines of electric force 42 are partially interrupted by the finger 8 (see (b) of FIG. 5). This generates (i) a capacitance Ctf between the finger 8 and the drive electrode 40a and (ii) a capacitance Ctf between the finger 8 and the receive electrode 40b. Consequently, the capacitance Ctr between the drive electrode 40a and the receive electrode 40b is reduced.

Here, in a case where a driving voltage V is applied to the drive electrode 40a, an output from the receive electrode 40b is ultimately detected as V2=Ctr×V÷C (see (c) of FIG. 5). As such, the capacitance Ctr can be measured with the formula. By thus detecting a change of the measured capacitance Ctr, it is possible to detect whether or not the display surface is pressed by the finger 8.

(Necessity of Correcting Detection Signal)

As illustrated in FIG. 5, according to the liquid crystal display device 1 of the present embodiment, each of the drive electrode 40a and the receive electrode 40b is not a comb-teeth shaped electrode but is a plate-like electrode. As illustrated in FIG. 2, the drive electrode 40a and the receive electrode 40b are provided in a plane which is different from a plane in which the pixel electrode 20 is provided. Therefore, even in a case where an electric potential of the pixel electrode 20 varies depending on whether or not an image is displayed, the lines of electric force generated between the drive electrode 40a and the receive electrode 40b are not increased or decreased. With the configuration, in a case where identical pressings are made with respect to the display surface, completely identical detection signals are obtained regardless of whether or not an image is displayed. Therefore, it is not necessary to correct a detection signal depending on whether or not an image is displayed.

(Improvement in Sensing Efficiency)

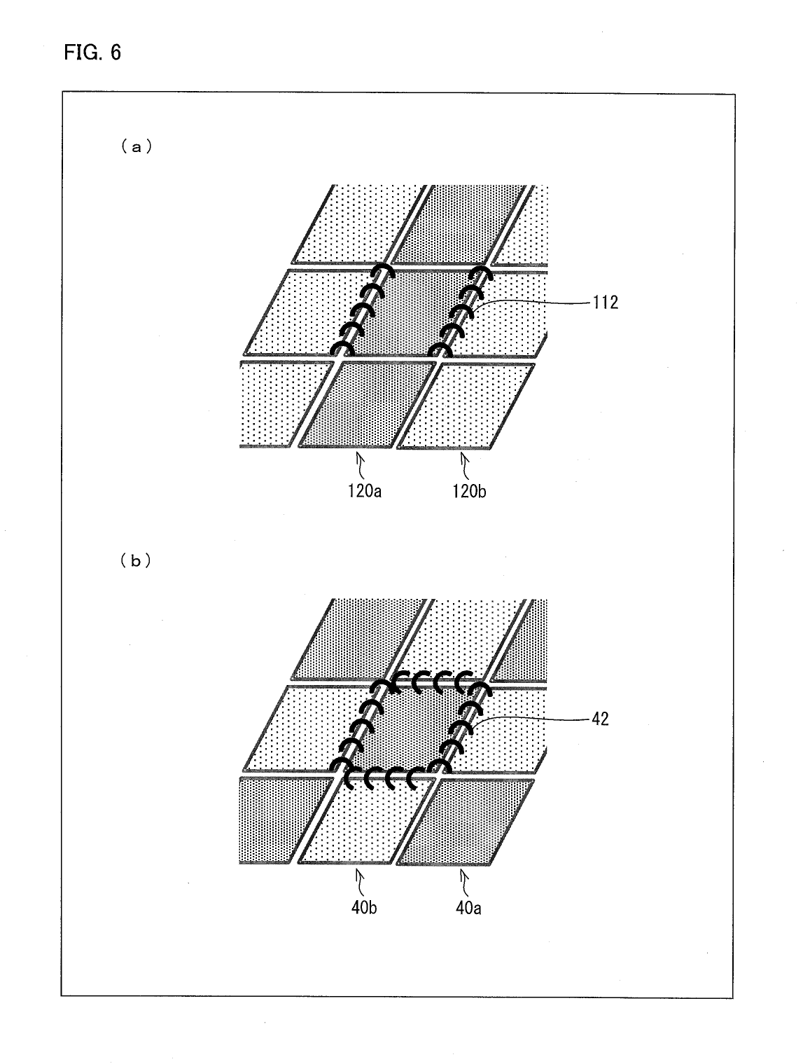

(a) of FIG. 6 illustrates lines of electric force 112 generated in a liquid crystal display device of a conventional technique, and (b) of FIG. 6 illustrates lines of electric force 42 generated in the liquid crystal display device 1 in accordance with an embodiment of the present invention.

According to the liquid crystal display device of the conventional technique, the drive electrodes 120a are aligned in one line, and the receive electrodes 120b are aligned in one line (see (a) of FIG. 6). Further, the lines of drive electrodes 120a and the lines of receive electrodes 120b are alternately arranged. According to the arrangement, the number of receive electrodes 120b, which abut on a certain one drive electrode 120a, is at most two. That is, the certain one drive electrode 120a forms lines of electric force 112, which contribute to sensing, merely with the abutting two receive electrodes 120b.

On the other hand, according to the liquid crystal display device 1 in accordance with an embodiment of the present invention, the drive electrodes 40a and the receive electrodes 40b are arranged in a staggered manner (see (b) of FIG. 6). According to the arrangement, a certain one drive electrode 40a is surrounded by four receive electrodes 40b. That is, the certain one drive electrode 40a forms lines of electric force 42, which contribute to sensing, with the abutting four receive electrodes 40b.

As illustrated in (a) and (b) of FIG. 6, according to the liquid crystal display device 1 in accordance with an embodiment of the present invention, the lines of electric force 42 which contribute to sensing become twice as many as those in the liquid crystal display device in accordance with the conventional technique. Therefore, sensitivity becomes twice. Note that, since the arrangement pattern of the drive electrodes 40a and the receive electrodes 40b is different from that of the drive electrodes 120a and the receive electrodes 120b, a sensing resolution of the liquid crystal display device 1 in accordance with an embodiment of the present invention becomes 1/√2 of that of the liquid crystal display device illustrated in (a) of FIG. 6. However, since the sensitivity is twice as high as that of the conventional liquid crystal display device, sensing efficiency consequently becomes √2 times higher, that is, the sensing efficiency is improved by 1.4 times, as compared with the conventional liquid crystal display device.

As above described, according to the liquid crystal display device 1 in accordance with an embodiment of the present invention, the drive electrodes 40a and the receive electrodes 40b are arranged in the staggered manner. This makes it possible to improve sensing efficiency, as compared with the liquid crystal display device in accordance with the conventional technique.

(Main Points)

As above described, according to the liquid crystal display device 1 in accordance with the present embodiment, each of the common electrodes 24, which have a plate-like shape and are provided independently for respective pixels, is connected with any of the CSY lines 14 or with any of the CSX lines 16. Common electrodes 24 connected with the CSY lines 14 serve as drive electrodes 40a of the touch panel. Meanwhile, common electrodes 24 connected with the CSX lines 16 serve as receive electrodes 40b of the touch panel. As such, an in-cell touch panel is provided in the liquid crystal display device 1.

According to the liquid crystal display device 1, each of the drive electrode 40a and the receive electrode 40b has a plate-like shape and is provided in a plane which is different from a plane in which the pixel electrode 20 is provided. Therefore, there is no cause that increases or decreases an electric potential distribution generated between the drive electrode 40a and the receive electrode 40b. From this, it is not necessary to correct a detection signal, which is generated when a pressing on the display surface is detected, depending on whether or not an image is displayed.

Whether each of the common electrodes 24 serves as a drive electrode or as a receive electrode is determined based on whether the common electrode 24 is connected with a CSY line 14 or with a CSX line 16. Therefore, in a case where a block is intended to be made up of a certain number of common electrodes 24, such a block can be configured by merely connecting the certain number of common electrodes 24 to CSY lines 14. That is, in a case where a plurality of common electrodes 24 are grouped into a block, it is not necessary to (i) electrically connect the CSY line 14 with the CSX line 16 or (ii) provide disconnecting parts at arbitrary locations on the CSY line 14 and on the CSX line 16. Therefore, according to the liquid crystal display device 1 in accordance with an embodiment of the present invention, it is possible to flexibly configure a drive electrode block and a receive electrode block which have arbitrary shape and size.

According to the liquid crystal display device in accordance with an aspect of the present invention, it is preferable that some of the common electrodes, each of which is connected with any of the plurality of drive lines, and the other of the common electrodes, each of which is connected with any of the plurality of receive lines, are arranged in a staggered manner.

According to the configuration, the number of receive electrodes, which abut on one (1) drive electrode, becomes up to four. Therefore, the number of lines of electric force formed between the drive electrode and the receive electrodes becomes twice as many as that obtained in a configuration in which drive electrodes and receive electrodes are arranged in a stripe manner. This makes it possible to further enhance sensing efficiency.

According to the liquid crystal display device in accordance with an aspect of the present invention, it is preferable that the plurality of drive lines are grouped into bundles each of which has a predetermined number of drive lines arranged side by side, the predetermined number of drive lines being connected with one (1) common drive line; and the plurality of receive lines are grouped into bundles each of which has a predetermined number of receive lines arranged side by side, the predetermined number of receive lines being connected with one (1) common receive line.

According to the configuration, a plurality of common electrodes, which are connected with the predetermined number of the plurality of drive lines, can be used as one (1) drive electrode block. Meanwhile, a plurality of common electrodes, which are connected with the predetermined number of the plurality of receive lines, can be used as one (1) receive electrode block. With the configuration, by changing the number of bundled drive lines and the number of bundled receive lines as appropriate, it is possible to form a drive electrode block and a receive electrode block which have intended sizes.

According to the liquid crystal display device in accordance with an aspect of the present invention, it is preferable that the pixel electrodes and the common electrodes are configured so as to correspond to an advanced fringe field switching mode.

According to the configuration, it is possible to enhance an aperture ratio of a pixel and to sufficiently increase a viewing angle of the liquid crystal display device 1.

(Example of Block Patterns)

According to the liquid crystal display device 1, the drive electrode blocks and the receive electrode blocks can have any of various shapes and arrangements. It is therefore possible to easily diversify an intended wiring pattern which is to be formed in the touch panel.

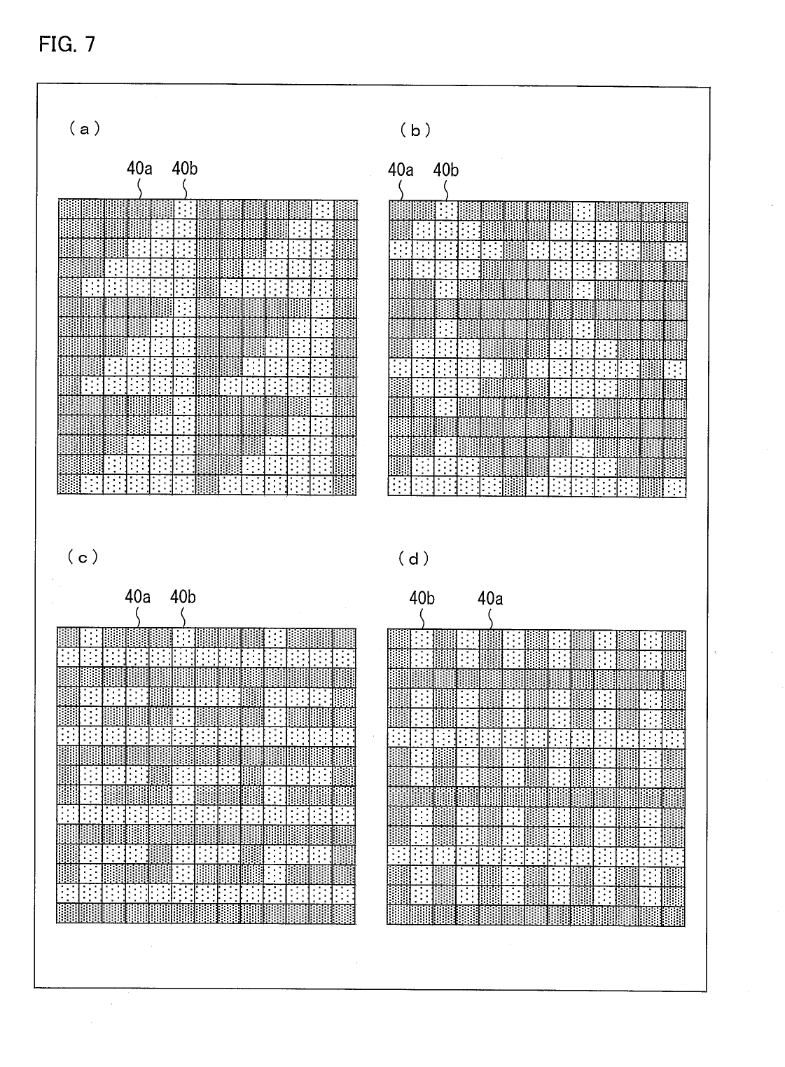

FIG. 7 is a view illustrating various patterns of the drive electrode blocks and the receive electrode blocks. As illustrated in (a) of FIG. 7, according to the liquid crystal display device 1 of the present embodiment, it is possible to easily provide a pattern, in which slider patterns are aligned in a plane, by grouping the drive electrodes 40a into a block and grouping the receive electrodes 40b into a block, although such a pattern has generally caused a problem of wiring layout when a size of a touch panel is increased. Moreover, it is also possible to easily provide (i) a general diamond pattern as illustrated in (b) of FIG. 7 and (ii) wiring patterns as illustrated in (c) and (d) of FIG. 7.

(Electrostatic Switch)

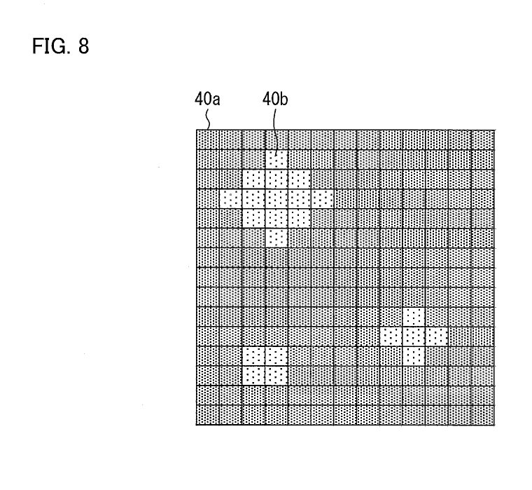

FIG. 8 is a view illustrating an electrostatic switch which is provided in the liquid crystal display device 1 and is configured by the drive electrodes 40a. As illustrated in FIG. 8, by grouping a plurality of drive electrodes 40a into a block, it is possible to provide an electrostatic switch in the liquid crystal display device 1. FIG. 8 illustrates electrostatic switches having a diamond shape, a cross shape, and a square shape, respectively. Note, however, that these shapes are merely examples. An electrostatic switch can be provided in an arbitrary location and can be formed to have an arbitrary shape, depending on arranged locations and a pattern of the drive electrodes 40a. Alternatively, it is possible to configure an electrostatic switch by grouping receive electrodes 40b into a block, instead of grouping drive electrodes 40a.

As such, according to the liquid crystal display device 1, it is possible to enhance accuracy in detecting a pressing on the sensor surface. Further, it is possible to group the drive electrodes into a block and to group the receive electrodes into a block, more flexibly.

The present invention is not limited to the embodiments and the examples, but can be altered by a skilled person in the art within the scope of the claims. An embodiment derived from a proper combination of technical means altered within the scope of the claims is also encompassed in the technical scope of the present invention.

### INDUSTRIAL APPLICABILITY

The present invention is widely applicable to a liquid crystal display device including an in-cell touch panel.

### REFERENCE SIGNS LIST

1: Liquid crystal display device
2: TFT substrate
4: Color filter substrate
6: Liquid crystal layer
8: Finger
10: Gate bus line
12: Data bus line
14: CSY line (drive line)
16: CSX line (receive line)
18: TFT
20: Pixel electrode
22: Slit
24: Common electrode
26: Connection line
32: Insulating layer
30: Transparent substrate
34: Transparent substrate
36: Color filter
40a: Drive electrode
40b: Receive electrode
42: Line of electric force

1. A liquid crystal display device comprising:
a plurality of pixels which are arranged in a matrix manner for carrying out display;
pixel electrodes provided for the respective plurality of pixels, each of the pixel electrodes having a comb-teeth shaped region;
common electrodes which (i) are provided for the respective plurality of pixels and (ii) face the respective pixel electrodes via an insulating layer, each of the common electrodes having a plate-like shape;
a plurality of drive lines; and
a plurality of receive lines which perpendicularly intersect with the plurality of drive lines,
each of the common electrodes being connected with any of the plurality of drive lines or with any of the plurality of receive lines.

2. The liquid crystal display device as set forth in claim 1, wherein:
some of the common electrodes, each of which is connected with any of the plurality of drive lines, and the other of the common electrodes, each of which is connected with any of the plurality of receive lines, are arranged in a staggered manner.

3. The liquid crystal display device as set forth in claim 1, wherein:
the plurality of drive lines are grouped into bundles each of which has a predetermined number of drive lines arranged side by side, the predetermined number of drive lines being connected with one (1) common drive line; and
the plurality of receive lines are grouped into bundles each of which has a predetermined number of receive lines arranged side by side, the predetermined number of receive lines being connected with one (1) common receive line.

4. The liquid crystal display device as set forth in claim 1, wherein:
the pixel electrodes and the common electrodes are configured so as to correspond to an advanced fringe field switching mode.
